(19) United States
(12) Patent Application Publication
(10) Pub. No.: US 2016/0178560 A1
(43) Pub. Date: Jun. 23, 2016

(54) SYSTEM AND METHOD FOR ANALYTE MEASUREMENT

(71) Applicant: LifeScan Scotland Limited, Inverness (GB)

(72) Inventors: David ELDER, Inverness (GB); Rossano MASSARI, Milano (IT); Christian FORLANI, Milano (IT); Emanuele POZZI, Monza (IT)

(21) Appl. No.: 14/574,512

(22) Filed: Dec. 18, 2014

(51) Int. Cl. G01N 27/327

(52) U.S. Cl. CPC G01N 27/3273

(57) ABSTRACT

An analyte measurement system and method for determining a test strip current through an analyte of a physiological fluid sample on a test strip. The system includes a variable reference direct current voltage source and a fixed reference direct current voltage source forming a voltage bias across the electrodes of the test strip. The system also can include an integrator circuit comprising a capacitor and an operational amplifier. In one embodiment, a bias current circuit including a bias current resistor network, and provides a bias current. In another embodiment, the system can include an integrator circuit transistor switch configured to reset the integrator circuit.

### TECHNICAL FIELD

The subject matter disclosed herein relates generally to the field of medical devices, and particularly to analyte measurement systems, and related methods, for measuring an analyte of a physiological fluid sample.

### BACKGROUND

The determination (e.g., detection or concentration measurement) of an analyte in a physiological fluid sample is of particular interest in the medical field. For example, it can be desirable to determine glucose, ketone bodies, cholesterol, lipoproteins, triglycerides, acetaminophen or glycosylated hemoglobin (HbA1c) concentrations in a sample of urine, blood, plasma or interstitial fluid. Such determinations can be achieved using a biosensor (e.g., a disposable electrochemical-based test strip) and an analyte meter combination.

For example, a diabetic patient conventionally tests his or her blood glucose using an analyte meter and test strip. The test strip typically includes electrical contacts for mating with the analyte meter and a sample chamber that contains reagents (e.g., the enzyme glucose oxidase (GO) and a mediator) and at least two electrodes. A mediator, such as ferricyanide, is a compound that accepts electrons from an enzyme and then donates the electrons to an electrode. To begin the test, the test strip is inserted into the analyte meter and the user applies a blood sample to the sample chamber. The analyte meter then applies a voltage to the electrodes to cause oxidation of glucose to gluconic acid by the oxidized form of glucose oxidase, also referred to as an “oxidized enzyme.” The oxidized enzyme is converted to its reduced state (i.e., “reduced enzyme”). Next, the reduced enzyme is re-oxidized back to the oxidized enzyme by reaction with the oxidized mediator or ferricyanide. During the re-generation of the reduced enzyme back to its oxidized state (i.e., the oxidized enzyme), the oxidized mediator (or ferricyanide) is reduced to a reduced mediator (or ferrocyanide).

When the reactions set forth above are conducted with a voltage bias applied between two electrodes, a test current can be created by the electrochemical re-oxidation of the reduced mediator at the electrode surface. Since, in an ideal environment, the amount of ferrocyanide created during the chemical reaction described above is directly proportional to the amount of glucose in the sample positioned between the electrodes, the test current generated would be proportional to the glucose content of the sample. As the concentration of glucose in the sample increases, the amount of reduced mediator formed also increases; hence, there is a direct relationship between the test current, resulting from the re-oxidation of reduced mediator, and glucose concentration. In particular, the transfer of electrons across the electrical interface results in the flow of a test current (2 moles of electrons for every mole of glucose that is oxidized). The test current resulting from the introduction of glucose can, therefore, be referred to as a glucose signal. The analyte meter measures the resulting current and calculates the glucose level based on the current. A processor in the analyte meter can then determine the user's blood glucose (e.g., in mg glucose per dL of blood, or mmol glucose per L of blood) using the resulting electrical signals. After the test is completed, the test strip can be disposed.

In some applications, an analyte meter may require a wide dynamic range of potential test strip current measurements with a fixed voltage bias across the test strip. These required wider dynamic ranges of test strip current measurements make it more difficult to meet the required accuracy of low current measurement resolution across the range of potential test strip currents. Since typical, lower cost microcontrollers only include 12-bit analog-to-digital converters (ADCs), the analyte-detection circuitry required for the desired resolution must include multiple stages (e.g., several amplifier circuits), requiring additional electronic components at additional expense. Since these analyte meters are intended to be used repeatedly throughout the day, it desirable that such meters be as small as possible so that the user will not feel burdened while carrying one, making the need for additional electronic components less desirable. In addition, since these analyte meters generally operate on battery power for portability, it is also desirable that such meters have extended battery life by minimizing analyte-detection circuitry, while still providing the required accuracy and measurement resolution.

The discussion above is merely provided for general background information and is not intended to be used as an aid in determining the scope of the claimed subject matter.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1A illustrates a diagram of an exemplary analyte measurement system that includes an analyte meter;

FIG. 1B illustrates a block diagram of an exemplary data management unit of the exemplary analyte meter shown in FIG. 1A;

FIG. 2 illustrates a schematic diagram of an exemplary processor, test strip port connector (SPC), and Analog Front End (AFE) subsystem in an exemplary analyte measurement system;

FIG. 3 illustrates a schematic diagram of an exemplary bias current circuit resistor network used in the exemplary analyte measurement system of FIG. 2;

FIGS. 4A, 4B, and 4C illustrate exemplary plots of output voltage versus time for three different test strip currents measured by the exemplary analyte measurement system of FIG. 2;

FIG. 5 illustrates a flow diagram of an exemplary method for determining a test strip current measured by the exemplary analyte measurement system of FIGS. 2 and 3;

FIG. 6 illustrates a schematic diagram of an exemplary processor, test strip port connector (SPC), and Analog Front End (AFE) subsystem in another exemplary analyte measurement system; and

FIG. 7 is a high-level diagram showing components of a data-processing system.

### DETAILED DESCRIPTION OF ILLUSTRATIVE EMBODIMENTS

The following description relates to an exemplary analyte measurement system in accordance with certain exemplary embodiments and should be read with reference to the drawings. The detailed description illustrates by way of example, not by way of limitation, the principles of the invention. This description will clearly enable one skilled in the art to make and use the invention, and describes several embodiments, adaptations, variations, alternatives and uses of the invention.

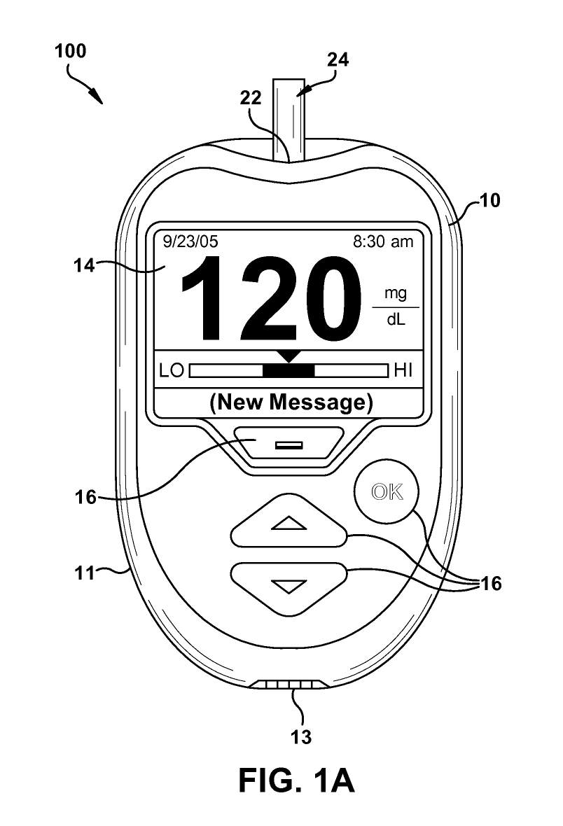

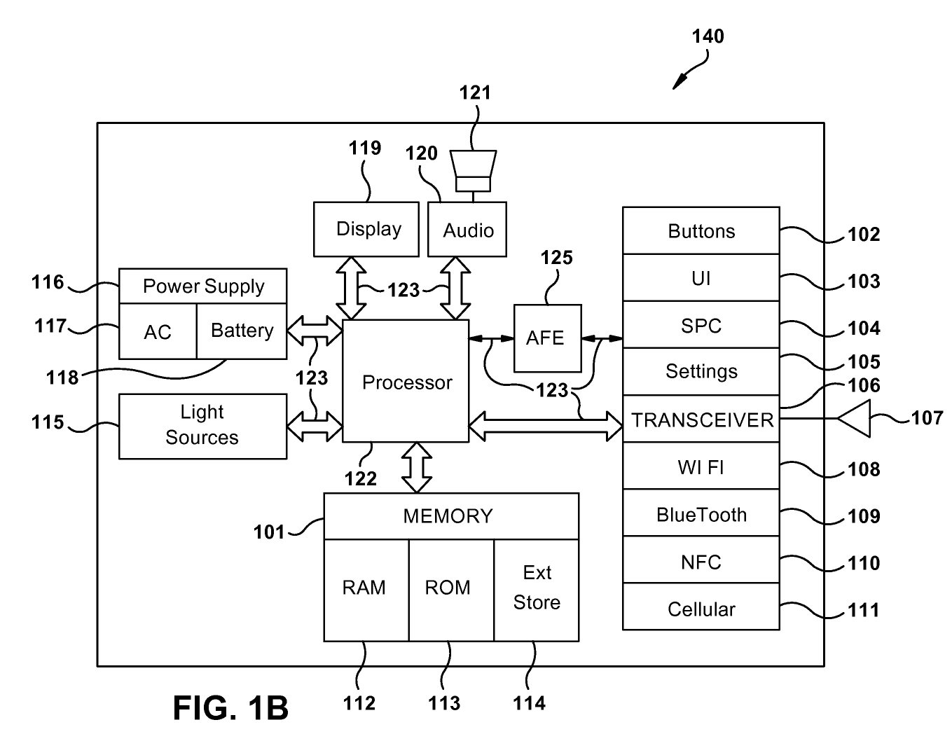

FIG. 1A illustrates a diagram of an exemplary analyte measurement system 100 that includes an analyte meter 10. FIG. 1B illustrates a block diagram of an exemplary data management unit 140 of the exemplary analyte meter 10 shown in FIG. 1A. The analyte meter 10 is defined by a meter housing 11 that retains a data management unit 140 and further includes a strip port opening 22 sized for receiving a biosensor. According to one embodiment, the analyte meter 10 may be a blood glucose meter and the biosensor is provided in the form of an analyte (e.g., glucose) test strip 24 inserted into strip port opening 22 for performing blood glucose measurements. The analyte meter 10 further includes a plurality of user interface buttons 16 and a display 14 as illustrated in FIG. 1A. A predetermined number of analyte test strips 24 may be stored in the meter housing 11 and made accessible for use in blood glucose testing. The plurality of user interface buttons 16 can be configured to allow the entry of data, to prompt an output of data, to navigate menus presented on the display 14, and to execute commands. Output data can include values representative of analyte concentration presented on the display 14. Input information, which is related to the everyday lifestyle of an individual, can include food intake, medication use, occurrence of health check-ups, and general health condition and exercise levels of an individual. These inputs can be requested via prompts presented on the display 14 and can be stored in a memory module 101 (FIG. 1B) of the analyte meter 10. Specifically and according to this exemplary embodiment, the user interface buttons 16 include markings, e.g., up-down arrows, text characters “OK”, etc, which allow a user to navigate through the user interface presented on the display 14. Although the buttons 16 are shown herein as separate switches, a touch screen interface on display 14 with virtual buttons may also be utilized.

The electronic components of the analyte measurement system 100 can be disposed on, for example, a printed circuit board situated within the meter housing 11 and forming the data management unit (DMU) 140 of the herein described system. FIG. 1B illustrates, in simplified schematic form, several of the electronic subsystems disposed within the meter housing 11 for purposes of this embodiment. The exemplary data management unit 140 includes a processor 122 in the form of a microprocessor, a microcontroller, an application specific integrated circuit (“ASIC”), a mixed signal processor (“MSP”), a field programmable gate array (“FPGA”), or a combination thereof, and is electrically connected to various electronic modules included on, or connected to, the printed circuit board, as will be described below. For example, in one embodiment, the processor 122 is available in the form of a mixed signal microprocessor (MSP) such as, for example, the Texas Instruments MSP 430 family of ultra-low power microcontrollers. In another embodiment, the processor 122 can be a 32-bit RISC microcontroller.

The processor 122 is electrically connected to, for example, a test strip port connector 104 (“SPC”) via a Analog Front End (“AFE”) subsystem 125. In the illustrated embodiment, the processor 122 is a microcontroller. The AFE subsystem 125 is electrically connected to the strip port connector 104 during blood glucose testing. To measure a selected analyte concentration, the AFE subsystem 125 detects a resistance across electrodes of analyte test strip 24 having a physiological fluid sample (e.g., a blood sample) disposed thereon, and converts an electric current measurement into digital form for presentation on the display 14. The processor 122 can be configured to receive input from the strip port connector 104, AFE subsystem 125, and may also perform a portion of the current measurement function. The analyte test strip 24 can be in the form of an electrochemical glucose test strip. The analyte test strip 24 can include one or more working electrodes at one end of the test strip 24. Analyte test strip 24 can also include a plurality of electrical contact pads at a second end of the test strip 24, where each electrode can be in electrical communication with at least one electrical contact pad. Strip port connector 104 can be configured to electrically interface to the electrical contact pads and form electrical communication with the electrodes. The SPC 104 can include spring contacts arranged so that the analyte test strip 24 can be slid into the SPC 104 to be releasably retained and also electrically connect to the test strip electrodes. Alternatively, the SPC 104 can include pogo pins, solder bumps, pin or other receptacles, jacks, or other devices for selectively and removably making electrical connections.

Analyte test strip 24 can include a reagent layer that is disposed over one or more electrodes within the test strip 24. The reagent layer can include an enzyme and a mediator. Exemplary enzymes suitable for use in the reagent layer include glucose oxidase, glucose dehydrogenase (with pyrroloquinoline quinone co-factor, “PQQ”), and glucose dehydrogenase (with flavin adenine dinucleotide co-factor, “FAD”). An exemplary mediator suitable for use in the reagent layer includes ferricyanide, which in this case is in the oxidized form. The reagent layer can be configured to physically transform glucose into an enzymatic by-product and in the process generate an amount of reduced mediator (e.g., ferrocyanide) that is proportional to the glucose concentration. The working electrode can then be used to measure a concentration of the reduced mediator in the form of a current. In turn, processor 122 can convert the current magnitude into a glucose concentration. An exemplary analyte meter performing such current measurements is described in U.S. Patent Application Publication No. US 1259/0301899 A1 entitled “System and Method for Measuring an Analyte in a Sample”, which is incorporated by reference herein as if fully set forth in this application.

A display module 119, which may include a display processor and display buffer, is electrically connected to the processor 122 over the communication interface 123 for receiving and displaying output data (e.g, test results or other information related to the test results), and for displaying user interface input options under control of processor 122. In one embodiment, the display module is an LCD screen.

The structure of the user interface, such as menu options, is stored in user interface module 103 and is accessible by processor 122 for presenting menu options to a user of the blood glucose measurement system 100. An audio module 120 includes a speaker 121 for outputting audio data received or stored by the DMU 140. Audio outputs can include, for example, notifications, reminders, and alarms, or may include audio data to be replayed in conjunction with display data presented on the display 14. Such stored audio data can be accessed by processor 122 and executed as playback data at appropriate times. A volume of the audio output is controlled by the processor 122, and the volume setting can be stored in settings module 105, as determined by the processor 122 or as adjusted by the user. Buttons module 102 receives inputs via user interface buttons 16 which are processed and transmitted to the processor 122 over the communication interface 123. The processor 122 may have electrical access to a digital time-of-day clock connected to the printed circuit board for recording dates and times of blood glucose measurements, which may then be accessed, uploaded, or displayed at a later time as necessary.

The display 14 can alternatively include a backlight whose brightness may be controlled by the processor 122 via a light source control module 115. Similarly, the user interface buttons 16 may also be illuminated using LED light sources electrically connected to processor 122 for controlling a light output of the buttons. The light source module 115 is electrically connected to the display backlight and processor 122. Default brightness settings of all light sources, as well as settings adjusted by the user, are stored in a settings module 105, which is accessible and adjustable by the processor 122.

A memory module 101, that includes but is not limited to volatile random access memory (“RAM”) 112, a non-volatile memory 113, which may comprise read only memory (“ROM”) or flash memory, and a circuit 114 for electrically connecting to an external portable memory device, for example, via a USB data port, is electrically connected to the processor 122 over a communication interface 123. External memory devices may include flash memory devices housed in thumb drives, portable hard disk drives, data cards, or any other form of electronic storage devices. The on-board memory can include various embedded applications and stored algorithms in the form of programs executed by the processor 122 for operation of the analyte meter 10, as will be explained below. On board memory can also be used to store a history of a user's blood glucose measurements including dates and times associated therewith. Using the wireless transmission capability of the analyte meter 10 or the data port 13, as described below, such measurement data can be transferred via wired or wireless transmission to connected computers or other processing devices.

A wireless module 106 may include transceiver circuits for wireless digital data transmission and reception via one or more internal antennas 107, and is electrically connected to the processor 122 over communication interface 123. The wireless transceiver circuits may be in the form of integrated circuit chips, chipsets, programmable functions operable via processor 122, or a combination thereof. Each of the wireless transceiver circuits is compatible with a different wireless transmission standard. For example, a wireless transceiver circuit 108 may be compatible with the Wireless Local Area Network IEEE 802.11 standard known as WiFi. Transceiver circuit 108 may be configured to detect a WiFi access point in proximity to the analyte meter 10 and to transmit and receive data from such a detected WiFi access point. A wireless transceiver circuit 109 may be compatible with the Bluetooth protocol or Bluetooth Low Energy protocol and is configured to detect and process data transmitted from a Bluetooth “beacon” (e.g., Smartphone or other master device) in proximity to the analyte meter 10. A wireless transceiver circuit 110 may be compatible with the near field communication (“NFC”) standard and is configured to establish radio communication with, for example, an NFC compliant point of sale terminal at a retail merchant in proximity to the analyte meter 10 or other mater device configured to receive data from the analyte meter 10. A wireless transceiver circuit 111 may comprise a circuit for cellular communication with cellular networks and is configured to detect and link to available cellular communication towers.

A power supply module 116 is electrically connected to all modules in the meter housing 11 and to the processor 122 to supply electric power thereto. The power supply module 116 may comprise standard or rechargeable batteries 118 or an AC power supply 117 may be activated when the analyte meter 10 is electrically connected to a source of AC power or a USB connection providing power. The power supply module 116 is also electrically connected to processor 122 over the communication interface 123 such that processor 122 can monitor a power level remaining in a battery power mode of the power supply module 116.

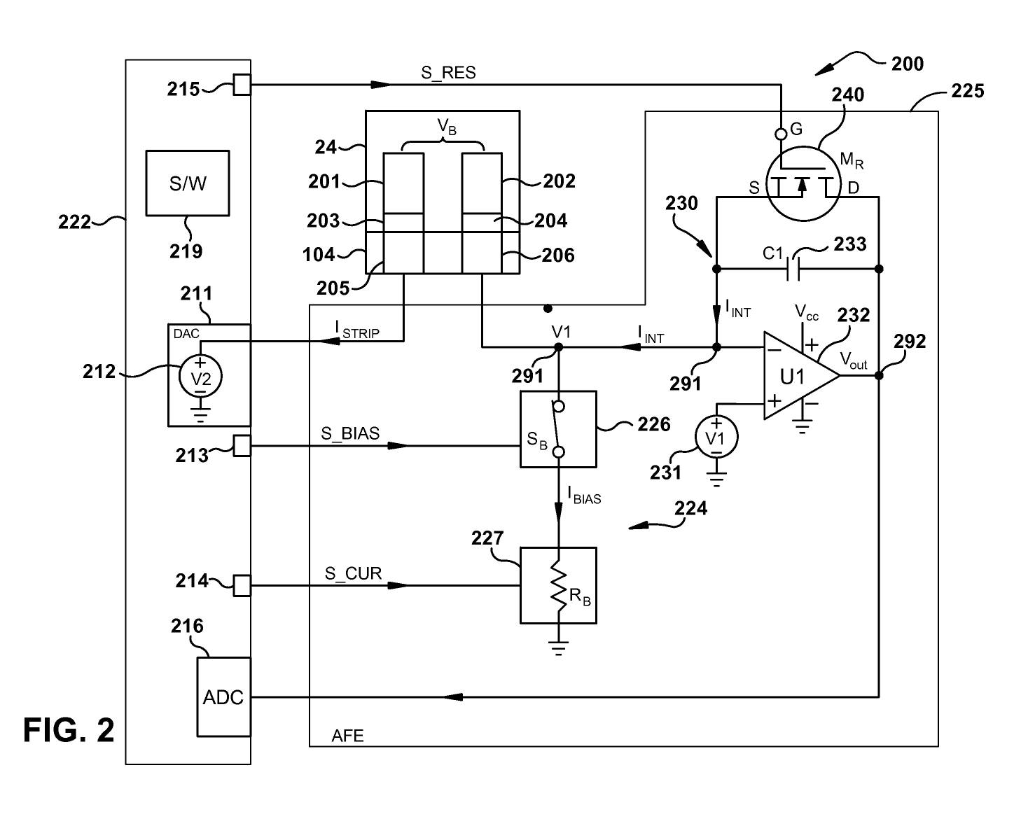

FIG. 2 illustrates a schematic diagram of an exemplary processor 222, test strip port connector (SPC) 104, and Analog Front End (AFE) subsystem 225 in an exemplary analyte measurement system 200. As described above, the processor 222 is electrically connected to the SPC 104 via the AFE subsystem 225. The AFE subsystem 225 is electrically connected to the SPC 104. In one embodiment, the analyte test strip 24 has a first (working) electrode 201 and a second (reference) electrode 202 at a one end of the analyte test strip 24. The analyte test strip 24 also includes a first contact pad 203 electrically connected to the first electrode 201 and a second contact pad 204 electrically connected to the second electrode 202. The SPC 104 can include a first electrical contact 205 to electrically connect to the first electrode 201 (via the first contact pad 203) when the analyte test strip 24 is inserted into the SPC 104, and can include a second electrical contact 206 to electrically connect to the second electrode 202 (via the second contact pad 204) when the analyte test strip 24 is inserted into the SPC 104. In one embodiment, these electrical contacts 205, 206 on the SPC 104 can be formed as prongs that are configured to electrically short the electrical contacts 205, 206 when the analyte test strip 24 is inserted, which can generate a signal transmitted to the processor 222 indicating that an analyte test strip 24 has been inserted into the SPC 104. Prior to placing a physiological fluid sample in the sample cell defined between the two electrodes 201, 202 in the analyte test strip 24, there is an open circuit between the two electrodes 201, 202. When a physiological fluid sample is applied to the analyte test strip 24 and the sample cell, the sample physically and electrically bridges the electrodes 201, 202 and becomes and electrical current conduction path for the test strip current (I_{STRIP}) between the electrodes 201, 202.

As shown in FIG. 2, the first (working) electrode 201 of the analyte test strip 24 is electrically connected to a variable reference DC (direct current) voltage source (V2) 212 via the first electrical contact 205 of the SPC 104. In the embodiment shown in FIG. 2, the analog variable reference DC voltage source (V2) 212 is provided by a digital-to-analog converter (DAC) 211 of the processor 222. In another embodiment, buffered switched resistor pairs can be used instead of a DAC. A fixed reference DC voltage source (V1) 231 is electrically connected to the non-inverting input (+) of an operational amplifier (U1) 232. The operational amplifier can be Model TLV2761 from Texas Instruments (instrumentation type, low voltage offset, low input bias current, low supply current). The variable reference DC voltage source (V2) 212 and the fixed reference DC voltage source (V1) 231 can be provided by a DAC of the processor 222 or independently of the processor 222.

The second (reference) electrode 202 of the analyte test strip 24 is electrically connected to the inverting input (−) of the operational amplifier (U1) 232 via the second electrical contact 206 of the SPC 104 through a first node 291, providing the fixed reference DC voltage source (V1) at the second electrode 202. Accordingly, the voltage bias (V_{B}) across the electrodes 201, 202 of the analyte test strip 24 (and the first electrical contact 205 and the second electrical contact 206 of the SPC 104) is the difference between the fixed reference DC voltage source (V1) 231 and the variable reference DC voltage source (V2) 212 (i.e., V_{B}=V1−V2). In one embodiment, the fixed referenced DC voltage source (V1) 231 can be +600 mV (0.60 V). If a variable DC voltage bias (V_{B}) across the analyte test strip 24 of, e.g., −200 mV to +600 mV, were desired, the variable reference DC voltage source (V2) 212 could provide DC voltages in the range of +800 mV to 0.0 mV. Software programs 219 (as part of data stored in memory module 101 (FIG. 1B)), including executable instructions, can be employed by the processor 222 to specify the voltage of the variable reference DC voltage source (V2) 212 to provide the desired voltage bias (V_{B}) across the analyte test strip 24.

As shown in FIG. 2 and discuss above, the fixed reference DC voltage source (V1) 231 is electrically connected to the non-inverting input (+) of the operational amplifier (U1) 232 while the second (reference) electrode 202 of the analyte test strip 24 is electrically connected to the inverting input (−) of the operational amplifier (U1) 232 through the first node 291. The output (V_{OUT}) of the operational amplifier (U1) 232 is electrically connected to a second node 292, which is electrically connected to an analog-to-digital converter (ADC) 216 of the processor 222 to measure the output (V_{OUT}) of the operational amplifier (U1) 232. The ADC 216 can be provided by the processor 222 or independently of the processor 222. A capacitor (C1) 233 is connected across the operational amplifier (U1) 232, with a first end of the capacitor (C1) 233 electrically connected to the first node 291 at the inverting input (−) of the operational amplifier (U1) 232 and the second end of the capacitor (C1) 233 electrically connected to the second node 292 at the output (V_{OUT}) of the operational amplifier (U1) 232. As will be explained, the integrator circuit 230, including the capacitor (C1) 233 and the operational amplifier (U1) 232, produces a linear voltage at the output (V_{OUT}) of the operational amplifier (U1) 232 at the second node 292 produced by the integrator current (I_{INT}) flowing through and charging the capacitor (C1) 233. The slope of the linear voltage at the output (V_{OUT}) of the operational amplifier (U1) 232 is proportional to the integrator current (I_{INT}) flowing through and charging the capacitor (C1) 233.

Processor 222 may include an interrupt (integrator circuit reset control output) 215 configured to control a transistor switch, which in one embodiment is in the form of an enhanced N-MOSFET (M_{R}) 240 (open (deactivate) and close (activate)) with a control signal sent on the S_RES control line. As used herein, the interrupts are typically General Purpose Input Output (GPIO) ports on the processor 122, 222, 622 that are configured as outputs under software control. The enhanced N-MOSFET (M_{R}) 240 is electrically connected in parallel across the capacitor (C1) 233, with the source (S) electrically connected to a first end of the capacitor (C1) 233 (the first node 291 at the inverting input (−) of the operational amplifier (U1) 232) and the drain (D) electrically connected to the second end (the second node 292 at the output of the operational amplifier (U1) 232). The gate (G) of enhanced N-MOSFET (M_{R}) 240 is electrically connected to the interrupt (integrator circuit reset control output) 215 of the processor 222 by the S_RES control line. The enhanced N-MOSFET (M_{R}) 240 is used to reset the integrator circuit 230 to a starting condition prior to determining the test strip current (I_{STRIP}). The interrupt (integrator circuit reset control output) 215 is set at a digital high level to activate (close) the enhanced N-MOSFET (M_{R}) 240, shorting the capacitor (C1) such that the voltage (charge) across the capacitor (C1) 233 is zero. After the voltage (charge) across the capacitor (C1) 233 is set to zero, the interrupt (integrator circuit reset control output) 215 is set at a digital low level to deactivate (open) the enhanced N-MOSFET (M_{R}) 240 to remove the short across the capacitor (C1) 233 allowing it to charge. Software programs 219 (as part of data stored in memory module 101 (FIG. 1B)), including executable instructions, can be employed by the processor 222 to determine when to reset the integrator circuit 230.

As mentioned above, the slope of the linear voltage at the output (V_{OUT}) of the operational amplifier (U1) 232 is proportional to the integrator current (I_{INT}) flowing through and charging the capacitor (C1) 233. It is desirable to ensure that the linear voltage at the output (V_{OUT}) of the operational amplifier (U1) 232 does not ramp downward/negatively (i.e., ensure that linear voltage is either flat or ramps upward/positively). In other words, it is desirable that the output (V_{OUT}) of the operational amplifier (U1) 232 does not become negative, which would be produced by a negative integrator current (I_{INT}). Maintaining a positive output (V_{OUT}) of the operational amplifier (U1) 232 keeps the enhanced N-MOSFET (M_{R}) 240 positively biased, preventing any conduction due to the FET's parasitic diode (from drain (D) to source (S)). If the output (V_{OUT}) of the operational amplifier (U1) 232 was permitted to be negative, back-to-back FETs or an analog switch would be required instead of a single enhanced N-MOSFET (M_{R}) 240 for resetting the integrator circuit 230.

As discussed, in some applications, a variable DC voltage bias (V_{B}) across the analyte test strip 24 could be desired spanning from a negative voltage (e.g., −200 mV) to a positive voltage (+600 mV). Similarly, the desired dynamic range (e.g., 60 μA) for the test strip current (I_{STRIP}) could span from a negative current (−20 μA) to a positive current (+40 μA). In order to ensure that a negative test strip current (I_{STRIP}) does not result in a negative integrator current (I_{INT}), the exemplary AFE 225 includes a bias current circuit 224 that provides a bias current (I_{BIAS}) that is equal to or greater than any potential negative test strip current (I_{STRIP}). For example, if the greatest potential negative test strip current (I_{STRIP}) is −20 μA, the bias current circuit 224 would provide a bias current (I_{BIAS}) of +20 μA. As shown in FIG. 2, the integrator current (I_{INT}) is equal to the sum of the test strip current (I_{STRIP}) and the bias current (I_{BIAS}) (i.e., I_{INT}=I_{STRIP}+I_{BIAS}). Accordingly, since the slope of the linear voltage at the output (V_{OUT}) of the operational amplifier (U1) 232 is proportional to the integrator current (I_{INT}) flowing through and charging the capacitor (C1) 233, that slope is proportional to the sum of the test strip current (I_{STRIP}) and the bias current (I_{BIAS}).

As shown in FIG. 2, the bias current circuit 224 can include a bias current circuit switch (S_{B}) 226 in series with a bias current circuit resistor network (R_{B}) 227. Bias current circuit switch (S_{B}) 226 may be in the form of a transistor switch such as a field-effect transistor (FET) (e.g., enhanced N-channel metal-oxide-semiconductor field-effect transistor (FET) (enhanced N-MOSFET)) and is configured to open to disconnect the bias current circuit 224 and to close to connect the bias current circuit 224. Processor 222 may include an interrupt (bias current circuit switch control output) 213 configured to control the bias current circuit switch (S_{B}) 226 (open and close the switch 226) with a control signal sent on the S_BIAS control line. For example, an interrupt (bias current circuit switch control output) 213 can be set at a digital high level to activate (close) the bias current circuit switch (S_{B}) 226, and set at a digital low level to deactivate (open) the bias current circuit switch (S_{B}) 226. When the bias current circuit switch (S_{B}) 226 is open, there is no bias current (I_{BIAS}=0.0 A) since the bias current circuit 224 is disconnected. In one embodiment, if a positive test strip current (I_{STRIP}) is expected (i.e., so there is no risk of a negative integrator current (I_{INT})), the bias current circuit switch (S_{B}) 226 can be opened. Eliminating the bias current (I_{BIAS}) shifts the greatest precision of measurement of test strip currents (I_{STRIP}) to the region just above 0.0 μA, which can be useful for taking low current background measurements. When the bias current circuit switch (S_{B}) 226 is closed, there is a bias current (I_{BIAS}>0.0 A) since the bias current (I_{BIAS}) can flow from the first node 291 to ground since the bias current circuit 224 is connected. In one embodiment, the bias current (I_{BIAS}) is equal to the voltage at the first node 291 (equal to the fixed reference DC voltage source (V1) 231 (e.g., +600 mV (0.60 V)) divided by the resistance of the bias current circuit resistor network (R_{B}) 227. For example, if the resistance of the bias current circuit resistor network (R_{B}) 227 is equal to 30 kΩ and the fixed reference DC voltage source (V1) 231 is +600 mV (0.60 V), the bias current (I_{BIAS}) is equal to +20 μA. Software programs 219 (as part of data stored in memory module 101 (FIG. 1B)), including executable instructions, can be employed by the processor 222 to determine when to provide a bias current (I_{BIAS}).

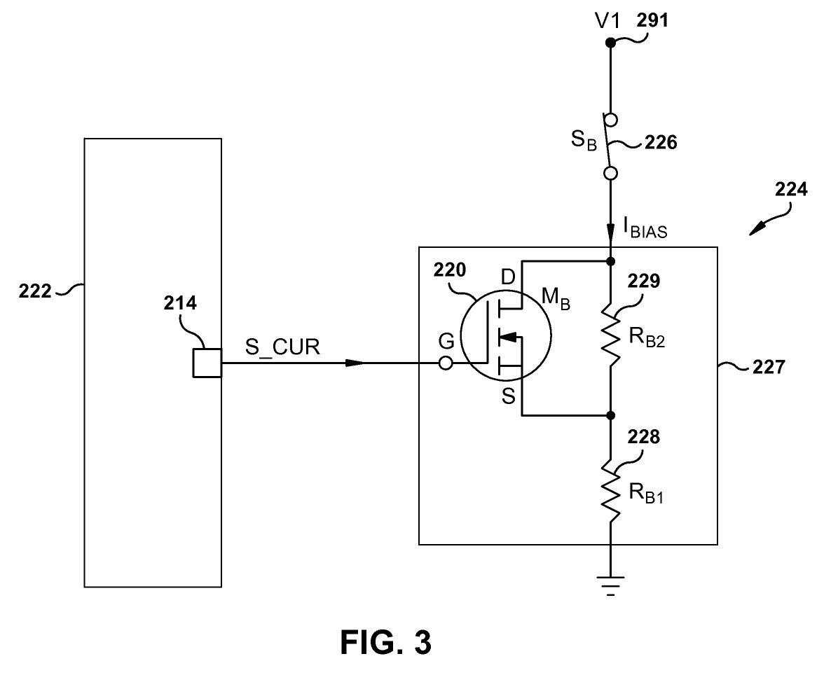

Processor 222 may also include an interrupt (bias current circuit resistor network control output) 214 configured to control the resistance value of the bias current circuit resistor network (R_{B}) 227 with a control signal sent on the S_CUR control line. This interrupt 214 allows the bias current circuit 224 to provide a different resistance value of the bias current circuit resistor network (R_{B}) 227 depending on the expected or measured test strip current (I_{STRIP}). FIG. 3 illustrates a schematic diagram of an exemplary bias current circuit resistor network (R_{B}) 227 used in the exemplary analyte measurement system 200 of FIG. 2. The exemplary bias current circuit resistor network (R_{B}) 227 shown in FIG. 3 includes a first bias current resistor (R_{B1}) 228 and a second bias current resistor (R_{B2}) 229 in series. In one embodiment, a transistor switch in the form of an enhanced N-MOSFET (M_{B}) 220 is electrically connected in parallel across the second bias current resistor (R_{B2}) 229, with the drain (D) being electrically connected to a first end of the second bias current resistor (R_{B2}) 229 and the source (S) electrically connected to a second end. The interrupt (bias current circuit resistor network control output) 214 is configured to control the enhanced N-MOSFET (M_{B}) 220 (open (deactivate) and close (activate)). The gate (G) of enhanced N-MOSFET (M_{B}) 220 is electrically connected to the interrupt (bias current circuit resistor network control output) 214 of the processor 222 by the S_CUR control line. The interrupt (bias current circuit resistor network control output) 214 can be set at a digital high level to activate (close) the enhanced N-MOSFET (M_{B}) 220, and set at a digital low level to deactivate (open) the enhanced N-MOSFET (M_{B}) 220. When the enhanced N-MOSFET (M_{B}) 220 is closed, the second bias current resistor (R_{B2}) is shorted such that the total resistance of the bias current circuit resistor network (R_{B}) 227 is equal to the resistance of the first bias current resistor (R_{B1}) 228 only. For example, if the resistance of the first bias current resistor (R_{B1}) 228 is equal to 30 kΩ and the fixed reference DC voltage source (V1) 231 is +600 mV (0.60 V), the bias current (I_{BIAS}) is equal to +20 μA.

When the enhanced N-MOSFET (M_{B}) 220 is open, the total resistance of the bias current circuit resistor network (R_{B}) 227 is equal to the sum of first bias current resistor (R_{B1}) 228 and a second bias current resistor (R_{B2}), reducing the bias current (I_{BIAS}). For example, if the resistance of the first bias current resistor (R_{B1}) 228 is equal to 30 kΩ and the resistance of the second bias current resistor (R_{B1}) 229 is equal to 90 kΩ, then the total resistance of the bias current circuit resistor network (R_{B}) 227 is equal to 120 kΩ. If the fixed reference DC voltage source (V1) 231 is 600 mV (0.60 V), the bias current (I_{BIAS}) would be reduced from +20 μA (when R_{B}=R_{B1}=30 kΩ) to +5 μA (R_{B}=R_{B1}+R_{B2}=120 kΩ). In one embodiment, if the analyte measurement system 200 determines that that the test strip current (I_{STRIP}) is in the predetermined range from −5.0 μA to +5.0 μA using a bias current (I_{BIAS}) of +20 μA, the processor 222 can use an interrupt (bias current circuit resistor network control output) 214 to change the resistance value of the bias current circuit resistor network (R_{B}) 227 in order to reduce the bias current (I_{BIAS}) to +5.0 μA and perform the measurement of the test strip current (I_{STRIP}) again using the smaller bias current (I_{BIAS}). The foregoing allows for more precise and accurate measurement (resolution less than 4 nA) in the range of test strip currents (I_{STRIP}) spanning from −5.0 μA to +5.0 μA where measurement tolerances are typically smaller. Software programs 219 (as part of data stored in memory module 101 (FIG. 1B)), including executable instructions, can be employed by the processor 222 to determine the desired resistance value of the bias current circuit resistor network (R_{B}) 227.

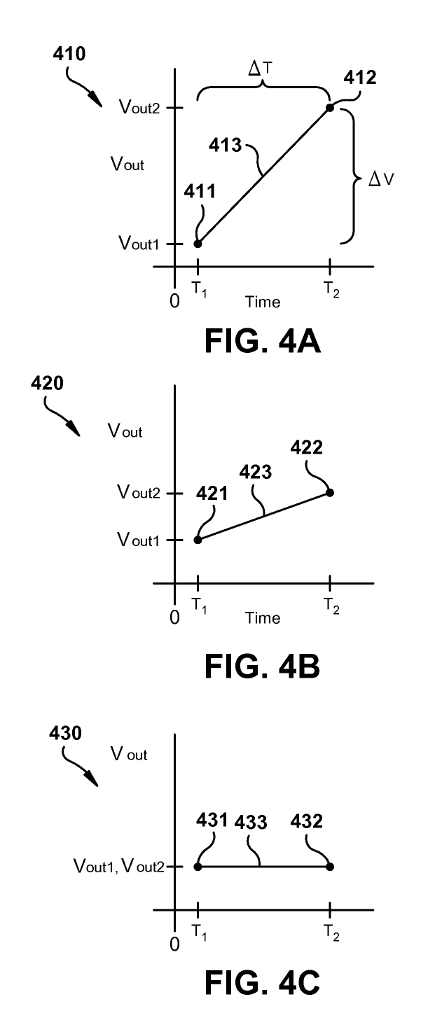

FIGS. 4A, 4B, and 4C illustrate exemplary plots 410, 420, 430 of the linear voltage at the output (V_{OUT}) of the operational amplifier (U1) 232 versus time for three (3) different test strip currents (I_{STRIP}) measured by the exemplary analyte measurement system 200 of FIG. 2. As discussed previously, the slope of the linear voltage at the output (V_{OUT}) of the operational amplifier (U1) 232 is proportional to the sum of the test strip current (I_{STRIP}) and the bias current (I_{BIAS}) (i.e., I_{INT}=I_{STRIP}+I_{BIAS}). In these exemplary plots 410, 420, 430, the bias current (I_{BIAS}) is equal to +20 μA. In each of these plots, the processor 222 determines the output voltage (V_{OUT}) of the operational amplifier (U1) 232, received by the ADC 216 at a first time (T₁) and then a second time (T₂) (using a timer) and determines the test strip current (I_{STRIP}) based on the change of the output voltage (V_{OUT}) (ΔV) versus the change in time (ΔT) (the time window). In the first exemplary plot 410, the first output voltage (V_{OUT1}) 411 at a first time (T₁) and the second output voltage (V_{OUT2}) 412 at a second time (T₂) produce a ramped first linear voltage 413 that is proportional to a test strip current (I_{STRIP}) of +40 μA. One benefit of subtracting the output voltage at the start (T₁) from the output voltage at the end (T₂) of the ramped first linear voltage is that the difference provides a slope value that is independent of any voltage offset in the operational amplifier (U1) 232 or any tolerance issues in the fixed reference DC voltage source (V1) 231.

In the second exemplary plot 420, the first output voltage (V_{OUT1}) 421 at a first time (T₁) and the second output voltage (V_{OUT2}) 422 at a second time (T₂) produce a ramped second linear voltage 423 that is proportional to a test strip current (I_{STRIP}) of +10 μA. In the third exemplary plot 430, the first output voltage (V_{OUT1}) 431 at a first time (T₁) and the second output voltage (V_{OUT2}) 432 at a second time (T₂) produce a flat third linear voltage 433 that is proportional to a test strip current (I_{STRIP}) of −20 μA. As seen in the third plot 430, since the test strip current (I_{STRIP}) of −20 μA and the bias current (I_{BIAS}) of +20 μA cancel to produce an integrator current (I_{INT}) of zero, the voltage at the output (V_{OUT}) of the operational amplifier (U1) 232 remains flat and does not rise.

For each of the plots 410, 420, 430, the time (T=0) is the time when the enhanced N-MOSFET (M_{R}) 240 is deactivated (opened) to remove the short across the capacitor (C1) 233 allowing the capacitor (C1) 233 to charge. Typically, the first output voltage (V_{OUT1}) is measured at a first time (T₁) after T=0 to avoid the charge injection into the gate (G) of the enhanced N-MOSFET (M_{R}) 240.

In one embodiment, the time window (ΔT) between the first time (T₁) and the second time (T₂) is fixed regardless of the test strip current (I_{STRIP}) or the integrator current (I_{INT}). For a maximum integrator current (I_{INT}) of +60 μA (corresponding to a test strip current (I_{STRIP}) of 40 μA) the time window (ΔT) between the first time (T₁) and the second time (T₂) for a capacitor (C1) 233 value of C=5 nF is 116 μs, which is relatively fast given the high current charging the capacitor (C1) 233. In one embodiment, the time window (ΔT) between the first time (T₁) and the second time (T₂) is fixed regardless of the test strip current (I_{STRIP}) or the integrator current (I_{INT}). In other words, the same time window (ΔT) is used for large currents (that produce high/steep slopes of the linear voltage at the output (V_{OUT}) of the operational amplifier (U1) 232) as is used for small currents (that produce low/gentle slopes of the linear voltage at the output (V_{OUT}) of the operational amplifier (U1) 232). However, for greater precision for lower test strip currents (I_{STRIP}) or integrator currents (I_{INT}), the time window (ΔT) between the first time (T₁) and the second time (T₂) can be adjusted (e.g., lengthened) since the linear voltage at the output (V_{OUT}) of the operational amplifier (U1) 232 ramps up more slowly. Software programs 219 (as part of data stored in memory module 101 (FIG. 1B)), including executable instructions, can be employed by the processor 222 to determine the time window (ΔT) between the first time (T₁) and the second time (T₂). Software programs 219 (as part of data stored in memory module 101 (FIG. 1B)), including executable instructions, can be employed by the processor 222 to determine the test strip current (I_{STRIP}) corresponding to the linear voltage at the output (V_{OUT}) of the operational amplifier (U1) 232. For example, test strip current (I_{STRIP}) can be determined since the integrator current (I_{INT}) is proportional to the difference between the first output voltage (V_{OUT1}) 431 at a first time (T₁) and the second output voltage (V_{OUT2}) 432 at a second time (T₂), and the strip current (I_{STRIP}) is equal to the integrator current (I_{INT}) minus the bias current (I_{BIAS}) (I_{STRIP}=I_{INT}−I_{BIAS}).

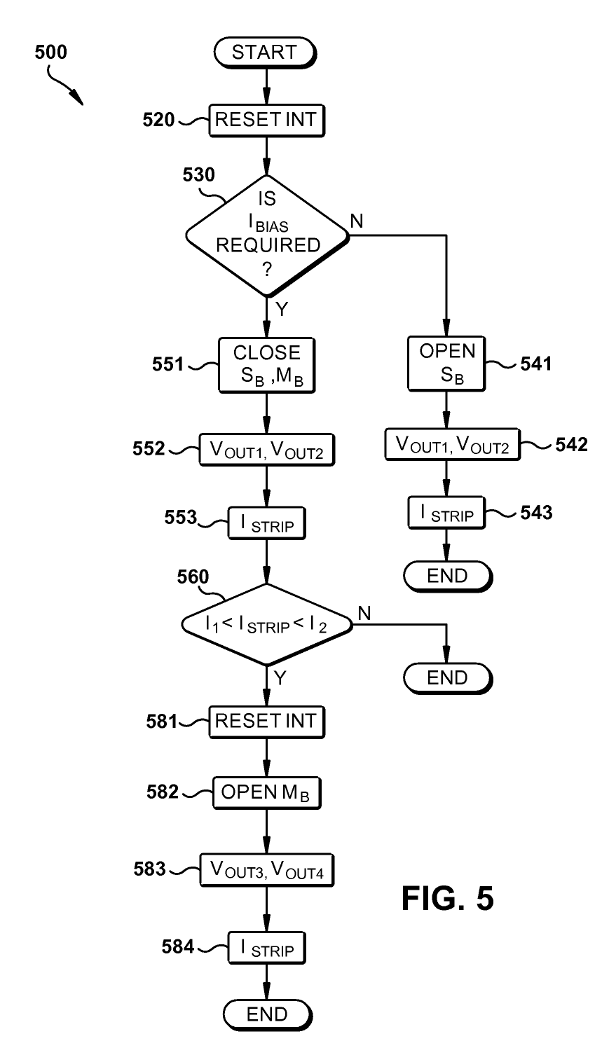

FIG. 5 illustrates a flow diagram of an exemplary method 500 for determining a test strip current (I_{STRIP}) measured by the exemplary analyte measurement system 200 of FIGS. 2 and 3 as discussed above. At step 520, the processor 222 resets the integrator circuit 230 to a starting condition using the enhanced N-MOSFET (M_{R}) 240. The interrupt (integrator circuit reset control output) 215 of the processor 222 is set at a digital high level to activate (close) the enhanced N-MOSFET (M_{R}) 240, shorting the capacitor (C1) such that the voltage (charge) across the capacitor (C1) 233 is zero. After the voltage (charge) across the capacitor (C1) 233 is set to zero, the interrupt (integrator circuit reset control output) 215 is set at a digital low level in order to deactivate (open) the enhanced N-MOSFET (M_{R}) 240 and remove the short across the capacitor (C1) 233 allowing the capacitor (C1) 233 to charge. At step 530, the processor 222 determines whether a bias current (I_{BIAS}) is required. For example, if the processor 222 determines that a positive test strip current (I_{STRIP}) is expected, a bias current (I_{BIAS}) may not be required.

If at step 530 a bias current (I_{BIAS}) is not required, at step 541, the processor 222 opens bias current circuit switch (S_{B}) 226 in the bias current circuit 224, eliminating the bias current (I_{BIAS}) with the open circuit. An interrupt (bias current circuit switch control output) 213 can be set at a digital low level to deactivate (open) the bias current circuit switch (S_{B}) 226. At step 542, the processor 222, using the ADC 216, measures the first output voltage (V_{OUT1}) of the operational amplifier (U1) 232 at a first time (T₁) and the second output voltage (V_{OUT2}) of the operational amplifier (U1) 232 at a second time (T₂) to determine the linear voltage at the output (V_{OUT}) of the operational amplifier (U1) 232. At step 543, the processor 222 determines the test strip current (I_{STRIP}) based on the integrator current (I_{INT}) corresponding to the linear voltage at the output (V_{OUT}) of the operational amplifier (U1) 232 (I_{STRIP}=I_{INT}−I_{BIAS}).

If at step 530 a bias current (I_{BIAS}) is required, at step 551, the processor 222 closes bias current circuit switch (S_{B}) 226 in the bias current circuit 224 to generate a bias current (I_{BIAS}). An interrupt (control output) 213 can be set at a digital high level to activate (close) the bias current circuit switch (S_{B}) 226. Also at step 551, the interrupt (bias current circuit resistor network control output) 214 can be set at a digital high level to activate (close) the enhanced N-MOSFET (M_{B}) 220, shorting the second bias current resistor (R_{B2}) such that the total resistance of the bias current circuit resistor network (R_{B}) 227 is equal to the resistance of the first bias current resistor (R_{B1}) 228 only, resulting in a higher bias current (I_{BIAS}). At step 552, the processor 222, using the ADC 216, measures the first output voltage (V_{OUT1}) of the operational amplifier (U1) 232 at a first time (T₁) and the second output voltage (V_{OUT2}) of the operational amplifier (U1) 232 at a second time (T₂) to determine the linear voltage at the output (V_{OUT}) of the operational amplifier (U1) 232. At step 553 the processor 222 determines the test strip current (I_{STRIP}) based on the integrator current (I_{INT}) corresponding to the linear voltage at the output (V_{OUT}) of the operational amplifier (U1) 232 (I_{STRIP}=I_{INT}−I_{BIAS}).

At step 560, the processor 222 determines whether the measured the test strip current (I_{STRIP}) is within a narrower predetermined range of currents (I₁<I_{STRIP}<I₂) (e.g. −5.0 μA to +5.0 μA) that might require another measurement of the test strip current (I_{STRIP}) with a lower bias current (I_{BIAS}). If the test strip current (I_{STRIP}) is not within a narrower range of currents, no further measurements are performed. If the test strip current (I_{STRIP}) is within a narrower range of currents, at step 581, the processor 222 resets the integrator circuit 230 to a starting condition using the enhanced N-MOSFET (M_{R}) 240 as discussed above. At step 582, the interrupt (bias current circuit resistor network control output) 214 can be set at a digital low level to deactivate (open) the enhanced N-MOSFET (M_{B}) 220 such that the total resistance of the bias current circuit resistor network (R_{B}) 227 is equal to the sum of first bias current resistor (R_{B1}) 228 and a second bias current resistor (R_{B2}), reducing the bias current (I_{BIAS}). At step 583, the processor 222, using the ADC 216, measures the third output voltage (V_{OUT3}) of the operational amplifier (U1) 232 at a third time (T₃) and the fourth output voltage (V_{OUT4}) of the operational amplifier (U1) 232 at a fourth time (T₄) to determine the linear voltage at the output (V_{OUT}) of the operational amplifier (U1) 232 at the second, lower bias current (I_{BIAS}). At step 584, the processor 222 determines the test strip current (I_{STRIP}) based on the integrator current (I_{INT}) corresponding to the linear voltage at the output (V_{OUT}) of the operational amplifier (U1) 232 (I_{STRIP}=I_{INT}−I_{BIAS}).

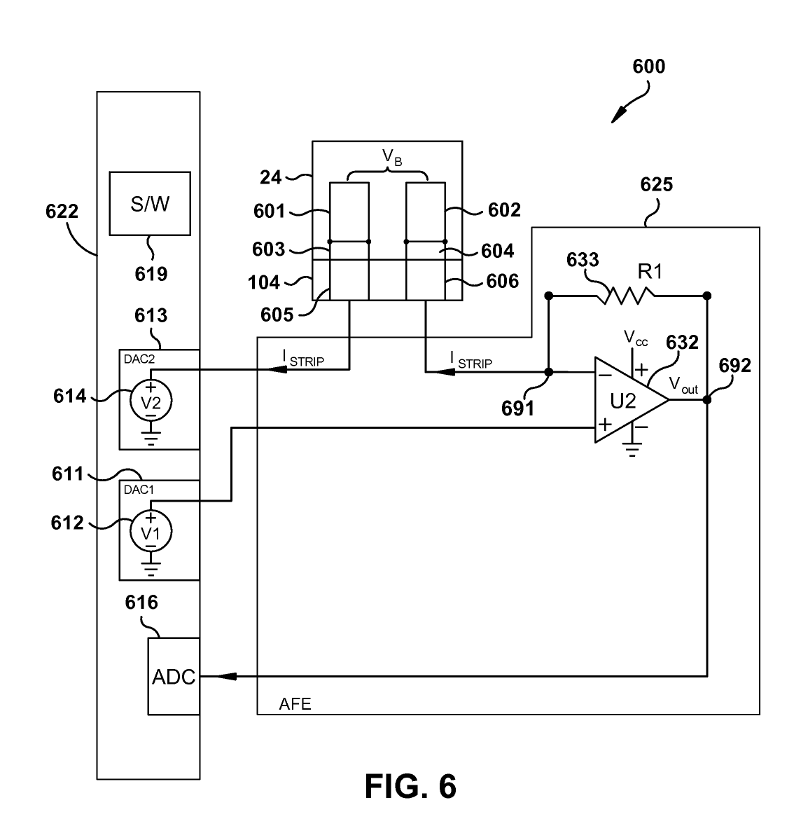

FIG. 6 illustrates a schematic diagram of an exemplary processor 622, test strip port connector (SPC) 104, and Analog Front End (AFE) subsystem 625 in another exemplary analyte measurement system 600. As described above, the processor 622 is electrically connected to the SPC 104 via the AFE subsystem 625. The AFE subsystem 625 is electrically connected to the SPC 104 during analyte testing. In one embodiment, the analyte test strip 24 has a first (working) electrode 601 and a second (reference) electrode 602 at a one end of the analyte test strip 24. The analyte test strip 24 also includes a first contact pad 603 electrically connected to the first electrode 601 and a second contact pad 604 electrically connected to the second electrode 602. The SPC 104 can include a first electrical contact 605 to electrically connect to the first electrode 601 (via the first contact pad 603) when the analyte test strip 24 is inserted into the SPC 104, and can include a second electrical contact 606 to electrically connect to the second electrode 602 (via the second contact pad 604) when the analyte test strip 24 is inserted into the SPC 104. In one embodiment, these electrical contacts 605, 606 on the SPC 104 can be formed as prongs that are configured to electrically short the electrical contacts 605, 606 when the analyte test strip 24 is inserted, which can generate a signal transmitted to the processor 622 indicating that an analyte test strip 24 has been inserted into the SPC 104. Prior to placing a physiological fluid sample in the sample cell between the two electrodes 601, 602 in the analyte test strip 24, there is an open circuit between the two electrodes 601, 602. When a physiological fluid sample is applied to the analyte test strip 24 and, more specifically, the sample cell of the test strip 24, the sample physically and electrically bridges the electrodes 601, 602 and becomes an electrical current conduction path for the test strip current (I_{STRIP}) between the electrodes 601, 602.

As shown in FIG. 6, the first (working) electrode 601 of the analyte test strip 24 is electrically connected to a second variable reference DC (direct current) voltage source (V2) 614. In the embodiment shown in FIG. 6, the analog second variable DC reference voltage source (V2) 614 is provided by a second digital-to-analog converter (DAC2) 613 of the processor 622. A first variable reference DC voltage source (V1) 612 is electrically connected to the non-inverting input (+) of an operational amplifier (U2) 632. The operational amplifier can be Model TLV2761 from Texas Instruments (instrumentation type, low voltage offset, low input bias current). In the embodiment shown in FIG. 6, the analog first variable reference DC voltage source (V1) 612 is provided by a first digital-to-analog converter (DAC1) 611 of the processor 622. The variable reference DC voltage sources (V1, V2) 612, 614 can be provided by DACs of the processor 622 or independently of the processor 622. The second (reference) electrode 602 of the analyte test strip 24 is electrically connected to the inverting input (−) of the operational amplifier (U2) 632 through a first node 691, providing the first variable reference DC voltage source (V1) 612 at the second electrode 602 when the operational amplifier (U2) 632 is operating linearly. Accordingly, the voltage bias (V_{B}) across the electrodes 601, 602 of the analyte test strip 24 is the difference between the first variable reference DC voltage source (V1) 612 and the second variable reference DC voltage source (V2) 614 (i.e., V_{B}=V1−V2).

As shown in FIG. 6 and discussed above, the first variable reference DC voltage source (V1) 612 is electrically connected to the non-inverting input (+) of the operational amplifier (U2) 632 while the second (reference) electrode 602 of the analyte test strip 24 is electrically connected to the inverting input (−) of the operational amplifier (U2) 632 through the first node 691. The output (V_{OUT}) of the operational amplifier (U2) 632 is electrically connected to a second node 692, which is electrically connected to an analog-to-digital converter (ADC) 616 of the processor 622 to measure the output (V_{OUT}) of the operational amplifier (U2) 632. The ADC 616 can be provided by the processor 622 or independently of the processor 622. In one embodiment, the output (V_{OUT}) of the operational amplifier (U2) 632 can vary from 0.0V to 2.0V, dependent upon the test strip current (I_{STRIP}), which is also the range of the ADC 616.

A resistor (R1) 633 is connected across the operational amplifier (U2) 632, with one end of the resistor (R1) 633 connected to the first node 691 at the inverting input (−) of the operational amplifier (U2) 632 and the other end of the resistor (R1) 633 connected to the second node 692 at the output (V_{OUT}) of the operational amplifier (U2) 632. The resistance value of resistor (R1) 633 can be selected based on the required test strip current (I_{STRIP}) measurement range (e.g., R1=10 kΩ to 200 kΩ). Software programs 619 (as part of data stored in memory module 101 (FIG. 1B)), including executable instructions, can be employed by the processor 622 to determine the test strip current (I_{STRIP}) corresponding to the voltage at the output (V_{OUT}) of the operational amplifier (U2) 632. For example, the test strip current (I_{STRIP}) can be determined by dividing the output (V_{OUT}) by the resistance value of the resistor (R1) 633.

In one embodiment, if a variable DC voltage bias (V_{B}) across the analyte test strip 24 of, e.g., −200 mV to +600 mV, were desired along with a dynamic range of potential test strip currents (I_{STRIP}) from, e.g., a negative current (−20 μA) to a positive current (+40 μA), the first variable reference DC voltage source (V1) 612 and the second variable reference DC voltage source (V2) 614 can be selected to provide the desired voltage bias (V_{B}) and dynamic range test strip currents (I_{STRIP}) while avoiding saturation of the operational amplifier (U2) 632 by targeting a smaller range of predicted test strip currents (I_{STRIP}). For example, if there is a negative voltage bias (V_{B}) across the analyte test strip 24, it is more likely that the test strip current (I_{STRIP}) will also be negative. Similarly, if there is a positive voltage bias (V_{B}) across the analyte test strip 24, it is more likely that the test strip current (I_{STRIP}) will also be positive.

As shown in the exemplary voltage and current values below in TABLE 1, by varying the first variable reference DC voltage source (V1) 612 for the first (working) electrode 601 and the second variable reference DC voltage source (V2) 614 for the second (reference) electrode 602, the voltage bias (V_{B}) across the analyte test strip 24 can be varied to provide a more targeted range of test strip currents (I_{STRIP}) without saturating the output (V_{OUT}) of the operational amplifier (U2) 632 by staying within the range of 0.0 V to +2.0 V.

TABLE 1

| V2 | V1 | V_{B} | I_{STRIP} | I_{STRIP} | V_{OUT} | V_{OUT} |
|---|---|---|---|---|---|---|
| (V) | (V) | (V) | Min (μA) | Max (μA) | Min (V) | Min (V) |
| −1.0 | −0.4 | 0.6 | 15 | 40 | 0.5 | 2 |
| 0.0 | 0.6 | 0.6 | −5 | 20 | 0.3 | 1.8 |
| 1.8 | 1.6 | −0.2 | −20 | 5 | 0.4 | 1.9 |

In one embodiment, the operational amplifier (U2) 632 can have a negative supply voltage instead of ground so as to ensure that the common mode input range of the operational amplifier (U2) 632 can also be negative. For example, if using Model TLV2761 from Texas Instruments, the positive power input could be +2.6V and the negative power input can be −1.0V.

Software programs 619 (as part of data stored in memory module 101 (FIG. 1B)), including executable instructions, can be employed by the processor 222 to specify the voltage of the variable first reference DC voltage source (V1) 612 and the second variable reference DC voltage source (V2) 614 to provide the desired voltage bias (V_{B}) across the analyte test strip 24.

In view of the foregoing, a technical effect of the various embodiments of the an exemplary analyte measurement system is to provide greater accuracy of test strip current measurements using several different bias voltages, and therefore, greater accuracy of analyte measurements over a greater dynamic range of possible measurements even with conventional 12-bit ADCs, while minimizing the quantity of electronic components required. By minimizing the quantity of electronic components required, the size, power demand, and cost of the analyte meter is advantageously minimized as well.

Throughout this description, some aspects are described in terms that would ordinarily be implemented as software programs. Those skilled in the art will readily recognize that the equivalent of such software can also be constructed in hardware (hard-wired or programmable), firmware, or micro-code. Accordingly, aspects of the present invention may take the form of an entirely hardware embodiment, an entirely software embodiment (including firmware, resident software, or micro-code), or an embodiment combining software and hardware aspects. Software, hardware, and combinations can all generally be referred to herein as a “service,” “circuit,” “circuitry,” “module,” or “system.” Various aspects can be embodied as systems, methods, or computer program products. Because data manipulation algorithms and systems are well known, the present description is directed in particular to algorithms and systems forming part of, or cooperating more directly with, systems and methods described herein. Other aspects of such algorithms and systems, and hardware or software for producing and otherwise processing signals or data involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

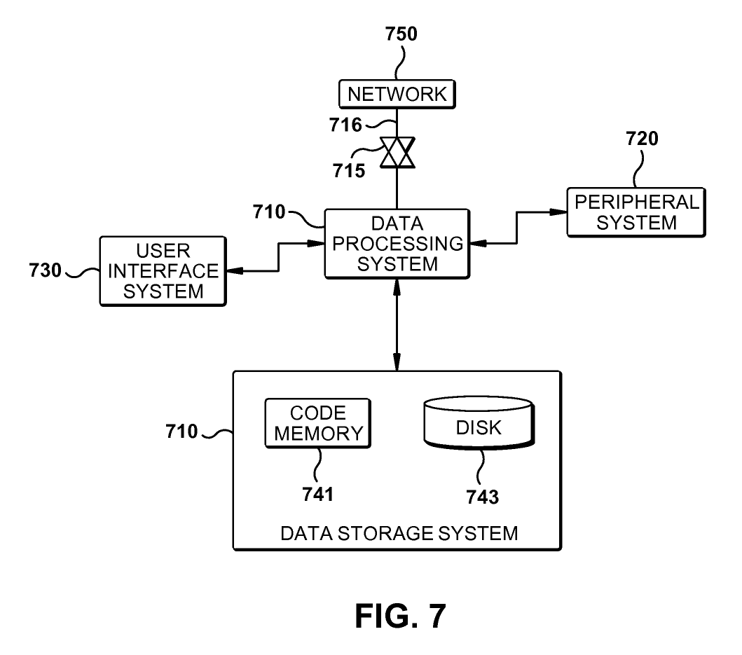

FIG. 7 is a high-level diagram showing the components of an exemplary data-processing system for analyzing data and performing other analyses described herein. The system includes a data processing system 710, a peripheral system 720, a user interface system 730, and a data storage system 740. The peripheral system 720, the user interface system 730 and the data storage system 740 are communicatively connected to the data processing system 710. Data processing system 710 can be communicatively connected to network 750, e.g., the Internet or an X.25 network, as discussed below. The processor 186, FIG. 1, can include or communicate with one or more of systems 710, 720, 730, 740, and can each connect to one or more network(s) 750.

The data processing system 710 includes one or more data processor(s) that implement processes of various aspects described herein. A “data processor” is a device for automatically operating on data and can include a central processing unit (CPU), a desktop computer, a laptop computer, a mainframe computer, a personal digital assistant, a digital camera, a cellular phone, a smartphone, or any other device for processing data, managing data, or handling data, whether implemented with electrical, magnetic, optical, biological components, or otherwise.

The phrase “communicatively connected” includes any type of connection, wired or wireless, between devices, data processors, or programs in which data can be communicated. Subsystems such as peripheral system 720, user interface system 730, and data storage system 740 are shown separately from the data processing system 710 but can be stored completely or partially within the data processing system 710.

The data storage system 740 includes or is communicatively connected with one or more tangible non-transitory computer-readable storage medium(s) configured to store information, including the information needed to execute processes according to various aspects. A “tangible non-transitory computer-readable storage medium” as used herein refers to any non-transitory device or article of manufacture that participates in storing instructions which may be provided to processor 186 for execution. Such a non-transitory medium can be non-volatile or volatile. Examples of non-volatile media include floppy disks, flexible disks, or other portable computer diskettes, hard disks, magnetic tape or other magnetic media, Compact Discs and compact-disc read-only memory (CD-ROM), DVDs, BLU-RAY disks, HD-DVD disks, other optical storage media, Flash memories, read-only memories (ROM), and erasable programmable read-only memories (EPROM or EEPROM). Examples of volatile media include dynamic memory, such as registers and random access memories (RAM). Storage media can store data electronically, magnetically, optically, chemically, mechanically, or otherwise, and can include electronic, magnetic, optical, electromagnetic, infrared, or semiconductor components.

Aspects of the present invention can take the form of a computer program product embodied in one or more tangible non-transitory computer readable medium(s) having computer readable program code embodied thereon. Such medium(s) can be manufactured as is conventional for such articles, e.g., by pressing a CD-ROM. The program embodied in the medium(s) includes computer program instructions that can direct data processing system 710 to perform a particular series of operational steps when loaded, thereby implementing functions or acts specified herein.

In an example, data storage system 740 includes code memory 741, e.g., a random-access memory, and disk 743, e.g., a tangible computer-readable rotational storage device such as a hard drive. Computer program instructions are read into code memory 741 from disk 743, or a wireless, wired, optical fiber, or other connection. Data processing system 710 then executes one or more sequences of the computer program instructions loaded into code memory 741, as a result performing process steps described herein. In this way, data processing system 710 carries out a computer implemented process. For example, blocks of the flowchart illustrations or block diagrams herein, and combinations of those, can be implemented by computer program instructions. Code memory 741 can also store data, or not: data processing system 710 can include Harvard-architecture components, modified-Harvard-architecture components, or Von-Neumann-architecture components.

Computer program code can be written in any combination of one or more programming languages, e.g., JAVA, Smalltalk, C++, C, or an appropriate assembly language. Program code to carry out methods described herein can execute entirely on a single data processing system 710 or on multiple communicatively-connected data processing systems 710. For example, code can execute wholly or partly on a user's computer and wholly or partly on a remote computer or server. The server can be connected to the user's computer through network 750.

The peripheral system 720 can include one or more devices configured to provide digital content records to the data processing system 710. For example, the peripheral system 720 can include digital still cameras, digital video cameras, cellular phones, or other data processors. The data processing system 710, upon receipt of digital content records from a device in the peripheral system 720, can store such digital content records in the data storage system 740.

The user interface system 730 can include a mouse, a keyboard, another computer (connected, e.g., via a network or a null-modem cable), or any device or combination of devices from which data is input to the data processing system 710. In this regard, although the peripheral system 720 is shown separately from the user interface system 730, the peripheral system 720 can be included as part of the user interface system 730.

The user interface system 730 also can include a display device, a processor-accessible memory, or any device or combination of devices to which data is output by the data processing system 710. In this regard, if the user interface system 730 includes a processor-accessible memory, such memory can be part of the data storage system 740 even though the user interface system 730 and the data storage system 740 are shown separately in FIG. 7.

In various aspects, data processing system 710 includes communication interface 715 that is coupled via network link 716 to network 750. For example, communication interface 715 can be an integrated services digital network (ISDN) card or a modem to provide a data communication connection to a corresponding type of telephone line. As another example, communication interface 715 can be a network card to provide a data communication connection to a compatible local-area network (LAN), e.g., an Ethernet LAN, or wide-area network (WAN). Wireless links, e.g., WiFi or GSM, can also be used. Communication interface 715 sends and receives electrical, electromagnetic or optical signals that carry digital data streams representing various types of information across network link 716 to network 750. Network link 716 can be connected to network 750 via a switch, gateway, hub, router, or other networking device.

Network link 716 can provide data communication through one or more networks to other data devices. For example, network link 716 can provide a connection through a local network to a host computer or to data equipment operated by an Internet Service Provider (ISP).

Data processing system 710 can send messages and receive data, including program code, through network 750, network link 716 and communication interface 715. For example, a server can store requested code for an application program (e.g., a JAVA applet) on a tangible non-volatile computer-readable storage medium to which it is connected. The server can retrieve the code from the medium and transmit it through the Internet, thence a local ISP, thence a local network, thence communication interface 715. The received code can be executed by data processing system 710 as it is received, or stored in data storage system 740 for later execution.

As used herein, the terms “patient” or “user” refer to any human or animal subject and are not intended to limit the systems or methods to human use, although use of the subject invention in a human patient represents a preferred embodiment. The term “sample”, as used herein, means a volume of a liquid, solution or suspension, intended to be subjected to qualitative or quantitative determination of any of its properties, such as the presence or absence of a component, the concentration of a component, e.g., an analyte, etc. The embodiments of the present invention are applicable to human and animal samples of whole blood. Typical samples in the context of the present invention as described herein include blood, plasma, red blood cells, serum and suspensions thereof. The term “about” as used in connection with a numerical value throughout the description and claims denotes an interval of accuracy, familiar and acceptable to a person skilled in the art. The interval governing this term is preferably +10%. Unless specified, the terms described above are not intended to narrow the scope of the invention as described herein and according to the claims.

### PARTS LIST FOR FIGS. 1-8

10 analyte meter
11 housing, meter
13 data port
14 display
16 user interface buttons
22 strip port opening
24 test strip
100 analyte measurement system
101 memory module
102 buttons module
103 user interface module
104 test strip port connector (SPC)
105 processor settings module
106 transceiver module
107 antenna
108 WiFi module
109 Bluetooth module
110 NFC module
111 GSM module
112 RAM module
113 ROM module
114 external storage
115 light source module
116 power supply module
117 AC power supply
118 battery power supply
119 display module
120 audio module
121 speaker
122 processor
123 communication interface
125 Analog Front End (AFE) subsystem
140 data management unit
200 analyte measurement system
201 first electrode (test strip)
202 second electrode (test strip)
203 first contact pad (test strip)
204 second contact pad (test strip)
205 first electrical contact (strip port circuit)
206 second electrical contact (strip port circuit)
211 digital-to-analog converter (DAC) (processor)
212 variable reference DC voltage source (V2) (processor)
213 interrupt (bias current circuit switch control output) (S_BIAS) (processor)
214 interrupt (bias current circuit resistor network control output) (S_CUR) (processor)
215 interrupt integrator circuit reset control output) (S_RES) (processor)
216 analog-to-digital converter (ADC) (processor)
219 software programs (processor)
220 MOSFET (M_{B})
222 processor
224 bias current circuit
225 Analog Front End (AFE) subsystem
226 bias current circuit switch (S_{B})
227 bias current circuit resistor network (R_{B})
228 first bias current resistor (R_{B1})
229 second bias current resistor (R_{B2})
230 integrator circuit
231 fixed reference DC voltage source (V1)
232 operational amplifier (U1)
233 capacitor (C1)
240 MOSFET (M_{R})
291 first node
292 second node
410 first plot
411 first output voltage (V_{OUT1})
412 second output voltage (V_{OUT2})
413 first linear ramped voltage
420 second plot
421 first output voltage (V_{OUT1})
422 second output voltage (V_{OUT2})
423 second linear ramped voltage
430 third plot
431 first output voltage (V_{OUT1})
432 second output voltage (V_{OUT2})
433 third linear ramped voltage
500 method
520, 530, 541-543, 551-553, 560, 581-584 steps
600 analyte measurement system
601 first electrode (test strip)
602 second electrode (test strip)
603 first contact pad (test strip)
604 second contact pad (test strip)
605 first electrical contact (strip port circuit)
606 second electrical contact (strip port circuit)
611 first digital-to-analog converter (DAC1) (processor)
612 first variable reference DC voltage source (V1) (processor)
613 second digital-to-analog converter (DAC2) (processor)
614 second variable reference DC voltage source (V2) (processor)
616 analog-to-digital converter (ADC) (processor)
619 software programs (processor)
622 processor
625 Analog Front End (AFE) subsystem
632 operational amplifier (U2)
633 resistor (R1)
691 first node
692 second node
710 data processing system
715 communication interface
716 network link
720 peripheral system
730 user interface system
740 data storage system
741 code memory
743 disk
750 network
I_{BIAS} bias current
I_{INT} integrator current
I_{STRIP} test strip current
S_BIAS interrupt line
S_CUR interrupt line
S_RES interrupt line

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An analyte measurement system for determining a test strip current through an analyte of a physiological fluid sample on a test strip comprising a first electrode and a second electrode, the analyte measurement system comprising:
a test strip port connector configured to receive the test strip, the test strip port connector comprising a first electrical contact configured to electrically connect to the first electrode and a second electrical contact configured to electrically connect to the second electrode;
an integrator circuit comprising a capacitor and an operational amplifier, wherein the first end of the capacitor is electrically connected to a first node at an inverting input of the operational amplifier and the second end of the capacitor is electrically connected to a second node at the output of the operational amplifier;
a variable reference direct current voltage source electrically connected to the first electrical contact of the test strip port connector;
a fixed reference direct current voltage source electrically connected to a non-inverting input of the operational amplifier, wherein the second electrical contact of the test strip connector is electrically connected to the first node at the inverting input of the operational amplifier, and wherein the fixed reference direct current voltage source and the variable reference direct current voltage source are configured to form a voltage bias across the first electrical contact and the second electrical contact of the test strip port connector;
a bias current circuit electrically connected between the first node and a ground, wherein the bias current circuit comprises a bias current resistor network, and wherein the bias current circuit is configured to provide a bias current through the bias current resistor network; and
a processor configured to measure the voltage at the output of the operational amplifier at the second node via an analog-to-digital converter electrically connected to the output of the operational amplifier at the second node, wherein the processor is configured to determine the test strip current based on the measured voltage.

2. The analyte measurement system of claim 1, wherein the bias current resistor network comprises a first bias current resistor, a second bias current resistor in series with the first bias current resistor, and a bias current resistor network transistor switch connected in parallel across the second bias current resistor.

3. The analyte measurement system of claim 2, wherein the processor further comprises a bias current circuit resistor network control output electrically connected to the bias current resistor network transistor switch, and wherein the bias current circuit resistor network control output is configured to open and close the bias current resistor network transistor switch.

4. The analyte measurement system of claim 2, wherein the bias current resistor network transistor switch comprises an enhanced N-channel MOSFET, and wherein the drain (D) is electrically connected to a first end of the second bias current resistor and the source (S) is electrically connected to a second end of the second bias current resistor.

5. The analyte measurement system of claim 4, wherein the processor further comprises a bias current circuit resistor network control output electrically connected to the gate (G) of the enhanced N-channel MOSFET, and wherein the bias current circuit resistor network control output is configured to open and close the enhanced N-channel MOSFET.

6. The analyte measurement system of claim 1, wherein the bias current circuit comprises a bias current circuit transistor switch configured to connect and disconnect the bias current circuit from the first node.

7. The analyte measurement system of claim 1, further comprising an integrator circuit transistor switch connected in parallel across the capacitor, wherein the integrator circuit transistor switch is configured to reset the integrator circuit.

8. The analyte measurement system of claim 7, wherein the integrator circuit transistor switch comprises an enhanced N-channel MOSFET, and wherein the source (S) is electrically connected to a first end of the capacitor and the drain (D) is electrically connected to a second end of the capacitor.

9. An analyte measurement system for determining a test strip current through an analyte of a physiological fluid sample on a test strip comprising a first electrode and a second electrode, the analyte measurement system comprising:
a test strip port connector configured to receive the test strip, the test strip port connector comprising a first electrical contact configured to electrically connect to the first electrode and a second electrical contact configured to electrically connect to the second electrode;
an integrator circuit comprising a capacitor and an operational amplifier, wherein the first end of the capacitor is electrically connected to a first node at an inverting input of the operational amplifier and the second end of the capacitor is electrically connected to a second node at the output of the operational amplifier;
a variable reference direct current voltage source electrically connected to the first electrical contact of the test strip port connector;
a fixed reference direct current voltage source electrically connected to a non-inverting input of the operational amplifier, wherein the second electrical contact of the test strip connector is electrically connected to the first node at the inverting input of the operational amplifier, and wherein the fixed reference direct current voltage source and the variable reference direct current voltage source are configured to form a voltage bias across the first electrical contact and the second electrical contact of the test strip port connector;
an integrator circuit transistor switch connected in parallel across the capacitor, wherein the integrator circuit transistor switch is configured to reset the integrator circuit; and
a processor configured to measure the voltage at the output of the operational amplifier at the second node via an analog-to-digital converter electrically connected to the output of the operational amplifier at the second node, wherein the processor is configured to determine the test strip current based on the measured voltage.

10. The analyte measurement system of claim 9, wherein the processor further comprises an integrator circuit reset control output electrically connected to the integrator circuit transistor switch, and wherein the integrator circuit reset control output is configured to open and close the integrator circuit transistor switch.

11. The analyte measurement system of claim 10, wherein the integrator circuit transistor switch comprises an enhanced N-channel MOSFET, and wherein the drain (D) is electrically connected to a first end of the capacitor and the source (S) is electrically connected to a second end of the capacitor.

12. The analyte measurement system of claim 11, wherein the processor further comprises an integrator circuit reset control output electrically connected to the gate (G) of the enhanced N-channel MOSFET, and wherein the integrator circuit reset control output is configured to open and close the enhanced N-channel MOSFET.

13. The analyte measurement system of claim 9, further comprising a bias current circuit electrically connected between the first node and a ground, wherein the bias current circuit comprises a bias current resistor network, and wherein the bias current circuit is configured to provide a bias current through the bias current resistor network.

14. The analyte measurement system of claim 13, wherein the bias current resistor network comprises a first bias current resistor, a second bias current resistor in series with the first bias current resistor, and a bias current resistor network transistor switch connected in parallel across the second bias current resistor.

15. The analyte measurement system of claim 14, wherein the bias current resistor network transistor switch comprises an enhanced N-channel MOSFET, and wherein the drain (D) is electrically connected to a first end of the second bias current resistor and the source (S) is electrically connected to a second end of the second bias current resistor.

16. The analyte measurement system of claim 13, wherein the bias current circuit comprises a bias current circuit transistor switch configured to connect and disconnect the bias current circuit from the first node.

17. The analyte measurement system of claim 16, wherein the bias current circuit transistor switch comprises one of a MOSFET and a FET switch.

18. A method for using an analyte measurement system to determine a test strip current through an analyte of a physiological fluid sample on a test strip, the analyte measurement system comprising a processor, a test strip port connector, an integrator circuit, and a bias current circuit, the method comprising:
generating a first bias current through the bias current circuit, wherein the bias current circuit comprises a first bias current resistor;
measuring a first output voltage of the integrator circuit at a first time using the processor;
measuring a second output voltage of the integrator circuit at a second time using the processor; and
determining the test strip current with the first bias current based on the difference between the first output voltage at the first time and the second output voltage at the second time using the processor.

19. The method of claim 18, further comprising:
using a processor, determining whether the test strip current measured with the first bias current is within a predetermined range;
if the test strip current measured with a first bias current is within a predetermined range, using the processor, resetting the integrator circuit using the processor;
using the processor, configuring the bias current circuit to comprise the first bias current resistor in series with a second bias current resistor;
generating a second bias current through the bias current circuit, wherein the second bias current is lower than the first bias current;
measuring a third output voltage of the integrator circuit at a third time using the processor;
measuring a fourth output voltage of the integrator circuit at a fourth time using the processor; and
determining the test strip current with the second bias current based on the difference between the third output voltage at the third time and the fourth output voltage at the fourth time using the processor.

20. The method of claim 18, further comprising:
using the processor, resetting the integrator circuit prior to the step of measuring a first output voltage of the integrator circuit.
